(19) United States
(12) Patent Application Publication
(10) Pub. No.: US 2025/0384750 A1
(43) Pub. Date: Dec. 18, 2025

(54) SYSTEMS AND METHODS FOR IN-VEHICLE MONITORING OF SMOKING EVENTS AND POST-ACCIDENT TRACKING

(71) Applicants: Michael G. Kaufman, Pepper Pike, OH (US); Steven Hendrix, Sagamore Hills, OH (US); Shervin Gorgani, Diamond Bar, OH (US)

(72) Inventors: Michael G. Kaufman, Pepper Pike, OH (US); Steven Hendrix, Sagamore Hills, OH (US); Shervin Gorgani, Diamond Bar, OH (US)

(21) Appl. No.: 19/241,773

(22) Filed: Jun. 18, 2025

Related U.S. Application Data
(60) Provisional application No. 63/661,268, filed on Jun. 18, 2024.

(51) Int. Cl. G08B 17/10; G06F 17/40; G06Q 50/40; G07C 5/00; G08B 17/12; G08B 29/04

(52) U.S. Cl. CPC G08B 17/10; G06F 17/40; G06Q 50/40; G07C 5/008; G08B 17/12; G08B 29/04

(57) ABSTRACT

The present disclosure provides an in-vehicle monitoring and tracking system for rental vehicles that detects smoking events within a vehicle cabin and logs these events with associated location data. The system employs specialized detection algorithms to accurately identify various types of smoke while minimizing false positives. Additional functionality includes accident detection through rapid deceleration monitoring, and animal presence detection through acoustic sensing. When events are detected, the system can either store the information for later retrieval or transmit real-time notifications with precise location data to rental company servers, enabling prompt response to policy violations and facilitating vehicle recovery after accidents.

### CROSS-REFERENCE TO RELATED APPLICATIONS

This application claims priority to U.S. Application No. 63/661,268, filed Jun. 18, 2024, which is hereby incorporated by reference in its entirety.

### BACKGROUND

Car rental companies often face challenges related to customers smoking in their vehicles, despite strict non-smoking policies. When a customer smokes in a rental vehicle, it requires extensive cleaning to remove odors and potential damage caused by smoke. This cleaning process can be time-consuming and costly for the rental company. Additionally, lingering smoke odors may negatively impact the experience of future customers who rent the vehicle.

Another issue faced by car rental companies is the difficulty in tracking the real-time location of their vehicles. Due to privacy concerns, many rental companies do not have the means to continuously monitor the exact location of their vehicles. This lack of real-time tracking can be problematic in situations where a rental vehicle is involved in an accident and towed from the scene. Without knowing the precise location of the vehicle, it can be challenging and time-consuming for the rental company to determine which impound lot their vehicle has been towed to, leading to increased costs and delays in recovering the vehicle.

Existing vehicle monitoring systems typically focus on theft prevention through tamper alarms or accident reporting through services that notify manufacturers rather than rental companies directly. These systems often lack proactive data collection capabilities and may not activate until after an incident has occurred.

There is a growing trend towards car sharing and ride sharing services as alternatives to traditional vehicle ownership. These services allow customers to reserve vehicles for short-term use or request rides on demand. However, the providers of these services face similar challenges to rental car companies in terms of monitoring vehicle usage, detecting policy violations, and tracking vehicle locations.

### BRIEF DESCRIPTION OF FIGURES

It is believed that certain embodiments will be better understood from the following description taken in conjunction with the accompanying drawings, in which like references indicate similar elements and in which:

FIG. 1 illustrates a system diagram of an in-vehicle smoke detector in accordance with one non-limiting embodiment.

FIG. 2 illustrates a system diagram of a vehicle environment with an in-vehicle smoke detector in accordance with one non-limiting embodiment.

FIG. 3 illustrates a block diagram of a vehicle power and communication system in accordance with one non-limiting embodiment.

FIG. 4 illustrates a flowchart for a method of detecting and logging smoking events within a vehicle cabin in accordance with one non-limiting embodiment.

FIG. 5 illustrates a flowchart for a method of monitoring and responding to vehicle accidents in accordance with one non-limiting embodiment.

### DETAILED DESCRIPTION

Various non-limiting embodiments of the present disclosure will now be described to provide an overall understanding of the principles of the structure, function, and use of the systems and methods as disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Components and modules can be implemented in software, hardware, or a combination of software and hardware. The term software is used expansively to include not only executable code, but also data structures, data stores, and computing instructions in any electronic format, firmware, and embedded software. The terms information and data are used expansively and can include a wide variety of electronic information, including, but not limited to, machine-executable or machine-interpretable instructions; content such as text, video data, and audio data, among others; and various codes or flags. The terms information, data, and content are sometimes used interchangeably when permitted by context.

The examples discussed herein are examples only and are provided to assist in the explanation of the systems and methods described herein. None of the features or components shown in the drawings or discussed below should be taken as mandatory for any specific implementation of any of these systems and methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel

The present disclosure relates to an in-vehicle smoke detection system designed to address multiple challenges faced by car rental companies and fleet managers. This system may provide a comprehensive solution for monitoring and managing rental vehicles, particularly in scenarios involving unauthorized smoking, accidents, and towing events that relocate the vehicle.

Car rental companies often encounter issues related to customers smoking in their vehicles, despite strict non-smoking policies. When a customer smokes in a rental vehicle, the vehicle may require extensive cleaning to remove the smoke odor and address any potential damage caused by the smoke. This cleaning process may be time-consuming and costly for the car rental company. Additionally, the lingering smoke odor may negatively impact the experience of future customers who rent the vehicle.

The in-vehicle smoke detection system described herein may address this problem by providing a reliable method for detecting and logging smoking events within the vehicle cabin. By utilizing specialized sensors and detection algorithms, the system may accurately identify when smoking has occurred, allowing rental companies to take appropriate action and potentially recover cleaning costs from the responsible customer.

Another challenge faced by car rental companies is the difficulty in tracking the location of their vehicles in real-time, particularly in post-accident scenarios. Due to privacy concerns and cost considerations, many car rental companies may not have the means to monitor the exact location of their vehicles at all times. This lack of real-time tracking can be problematic in situations where a rental vehicle is involved in an accident and removed from the scene via towing. Without knowing the precise location of the vehicle, it can be challenging and time-consuming for the car rental company to determine which impound lot their vehicle has been towed to, leading to increased costs and delays in recovering the vehicle.

The in-vehicle smoke detection system may address this issue by incorporating accident detection and location tracking capabilities. In the event of a sudden deceleration indicative of an accident, the system may automatically transmit the vehicle's location to the rental company, facilitating rapid response and recovery.

By combining these functionalities into a single, integrated system, the in-vehicle smoke detection system may provide car rental companies with a comprehensive tool for managing their fleet more effectively. The system may help reduce cleaning costs associated with unauthorized smoking, improve vehicle recovery times after accidents or towing events, and ultimately enhance the overall efficiency of rental operations.

The in-vehicle smoke detection system may be implemented in various embodiments to suit different needs and applications. In some cases, the system may be mounted behind the rear-view mirror of a vehicle. This location may provide optimal placement for detecting smoking events while remaining inconspicuous to vehicle occupants. Alternatively, the system may be positioned near the top of the vehicle's A-pillar, offering another effective mounting option that allows for comprehensive monitoring of the vehicle cabin.

The power module of the in-vehicle smoke detection system may incorporate different power source configurations. In some implementations, the power module may include a solar panel. The solar panel may be used for trickle charging a rechargeable battery, providing a sustainable and low-maintenance power solution. This configuration may be particularly beneficial for vehicles that spend significant time parked in sunlit areas.

In other embodiments, the power module may utilize a replaceable battery. This option may allow for easy maintenance and quick power source replacement when needed. Alternatively, the system may employ a rechargeable battery without solar charging capabilities. In yet another configuration, the power module may be hardwired directly to the vehicle electrical system, ensuring a constant power supply without the need for battery replacement or recharging.

For non-hardwired embodiments, the power module may employ an on/off duty cycle to conserve battery life. This power management technique may involve alternating between active monitoring periods and low-power standby modes. The duration and frequency of these cycles may be adjusted based on factors such as vehicle usage patterns, desired monitoring intensity, and battery capacity.

The sensor configuration of the in-vehicle smoke detection system may also vary across different embodiments. Some implementations may focus primarily on smoke detection, utilizing specialized smoke sensors designed to detect particles and chemicals associated with various smoking materials. Other configurations may incorporate additional sensors, such as accelerometers for accident detection or acoustic sensors for detecting animal sounds.

Communication methods may differ among various embodiments of the system. Some versions may rely on short-range wireless technologies, such as Bluetooth, for data transfer during vehicle check-in processes. Other implementations may include cellular communication modules, enabling real-time data transmission and alerts to rental company servers or fleet management systems.

These diverse embodiments of the in-vehicle smoke detection system may be tailored to meet specific needs of car rental companies or other fleet management applications. For instance, a basic configuration with smoke detection and local data storage may be suitable for smaller rental operations, while a more comprehensive system with real-time communication and multiple sensor types may benefit larger fleet managers requiring advanced monitoring capabilities.

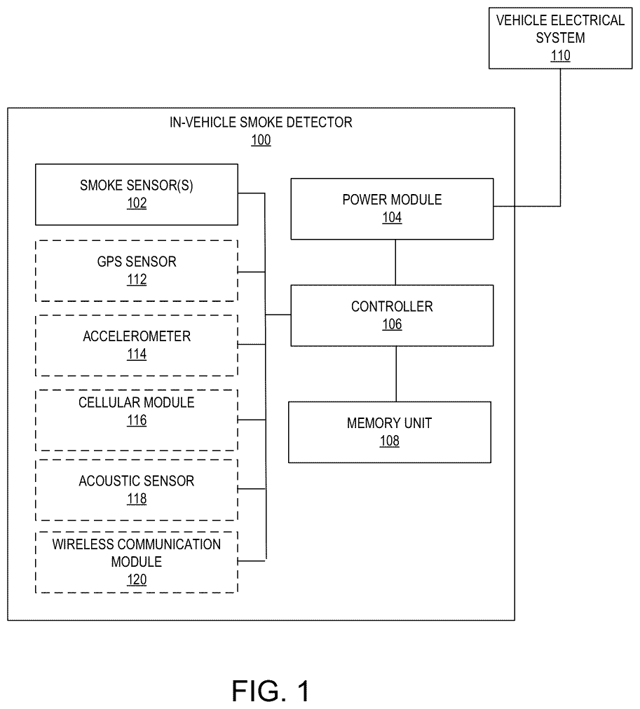

FIG. 1 illustrates a system diagram of an in-vehicle smoke detector 100. The in-vehicle smoke detector 100 may comprise multiple interconnected components designed to monitor various conditions within a vehicle cabin. The system diagram depicts the functional architecture and relationships between the different hardware and software elements that enable comprehensive vehicle monitoring capabilities.

A smoke sensor 102 may be included in the in-vehicle smoke detector 100. The smoke sensor 102 may be configured to detect particles and chemicals associated with smoke within the vehicle cabin. In some cases, the smoke sensor 102 may include ionization sensors, photoelectric sensors, or chemical sensors, or a combination thereof, to enhance detection capabilities for various types of smoke. The ionization sensors may detect smaller smoke particles typically produced by flaming fires, while photoelectric sensors may be more responsive to larger smoke particles generated by smoldering materials. Chemical sensors may specifically target compounds found in tobacco smoke, marijuana smoke, or vapor from electronic cigarettes.

The in-vehicle smoke detector 100 may include a power module 104. The power module 104 may be responsible for supplying and managing electrical power to the components of the in-vehicle smoke detector 100. In some implementations, the power module 104 may be connected to a vehicle electrical system 110, allowing the in-vehicle smoke detector 100 to draw power directly from the vehicle. The power module 104 may incorporate voltage regulators, power conditioning circuits, and backup power capabilities to ensure consistent operation even during fluctuations in the vehicle's electrical system. Additionally, the power module 104 may include power management features that optimize energy consumption based on the operational state of the vehicle and the monitoring requirements.

A controller 106 may be incorporated into the in-vehicle smoke detector 100. The controller 106 may serve as the central processing unit, managing inputs from various sensors and modules, and executing operational logic for the system. The controller 106 may be communicatively coupled to the smoke sensor 102 and other components of the in-vehicle smoke detector 100. The controller 106 may comprise a microprocessor or microcontroller with integrated or external memory, input/output interfaces, and communication buses. The controller 106 may execute firmware or software algorithms that process sensor data, make determinations about detected events, manage system resources, and control communication with external systems. The controller 106 may implement adaptive thresholds and filtering techniques to distinguish between actual smoking events and environmental factors that might trigger false positives.

The in-vehicle smoke detector 100 may also include a memory unit 108. The memory unit 108 may be connected to the controller 106 and may store operational data, recorded events, and system settings. In some cases, the memory unit 108 may log smoking events detected by the smoke sensor 102, along with associated timestamps and location data. The memory unit 108 may utilize non-volatile storage technology such as flash memory or EEPROM to retain data even when power is removed from the system. The memory unit 108 may be organized into different sections for storing various types of data, including system configuration parameters, event logs with detailed contextual information, diagnostic information, and firmware or software updates. The memory capacity may be sufficient to store months of operational data, depending on the frequency of detected events and the level of detail recorded for each event.

A GPS sensor 112 may be integrated into the in-vehicle smoke detector 100. The GPS sensor 112 may provide location data to the controller 106, allowing the system to record the geographic position of the vehicle when specific events occur. The GPS sensor 112 may include a satellite signal receiver, positioning circuitry, and potentially an integrated antenna or connection to an external antenna. The GPS sensor 112 may be capable of determining latitude, longitude, altitude, speed, and heading information. In some implementations, the GPS sensor 112 may support multiple satellite navigation systems such as GPS, GLONASS, Galileo, or BeiDou to improve accuracy and availability of position data. The controller 106 may process the raw GPS data to filter out erroneous readings and may implement algorithms to maintain location awareness even during temporary signal loss, such as when driving through tunnels or in urban canyons with limited satellite visibility.

An accelerometer 114 may be included in the in-vehicle smoke detector 100. The accelerometer 114 may detect movement and acceleration of the vehicle, providing data to the controller 106 for analysis of potential accidents. The accelerometer 114 may be a multi-axis sensor capable of measuring acceleration forces in three dimensions (X, Y, and Z axes). This capability allows the system to detect various types of vehicle movement, including forward/backward acceleration, side-to-side movement, and vertical motion. The accelerometer 114 may capture sudden high-g forces that could signify a collision. The controller 106 may apply digital filtering and pattern recognition algorithms to the accelerometer data to distinguish between normal driving conditions and potential accidents.

The in-vehicle smoke detector 100 may incorporate a cellular module 116. The cellular module 116 may enable wireless communication capabilities, allowing the system to transmit data or alerts to external systems or recipients. The cellular module 116 may include a modem, radio frequency circuitry, and antenna components necessary for establishing connections to cellular networks. The cellular module 116 may support various communication protocols and network technologies, such as 4G LTE, 5G, or NB-IoT, depending on the deployment region and communication requirements. The module may be capable of both voice and data transmission, though data services may be primarily utilized for sending event notifications, location updates, and system status information. The cellular module 116 may include SIM card functionality, either through a physical SIM card or embedded eSIM technology, to authenticate and connect to cellular networks. The controller 106 may manage the cellular module 116 to optimize power consumption by activating high-bandwidth communications only when necessary while maintaining low-power connectivity for critical alerts.

An acoustic sensor 118 may be part of the in-vehicle smoke detector 100. The acoustic sensor 118 may be configured to capture sound information within the vehicle cabin. In some implementations, the acoustic sensor 118 may be tuned to detect specific animal sounds such as barking or meowing, providing data to identify the presence of animals in the vehicle. The acoustic sensor 118 may comprise a microphone element, pre-amplification circuitry, and analog-to-digital conversion components. The sensor may have directional or omnidirectional pickup patterns depending on the monitoring requirements. The controller 106 may process the audio signals using spectral analysis, frequency filtering, and pattern matching algorithms to identify specific sound signatures while filtering out ambient noise and human conversation. This processing may help protect privacy by focusing only on detecting specific acoustic patterns rather than recording or analyzing speech content. The acoustic sensor 118 may operate at various sampling rates and bit depths to balance detection accuracy with processing and storage requirements.

A wireless communication module 120 may be included in the in-vehicle smoke detector 100. The wireless communication module 120 may allow for short-range wireless data transfer, potentially enabling communication with external devices for data retrieval or system configuration. The wireless communication module 120 may incorporate radio frequency circuitry, protocol stacks, and security features necessary for establishing secure connections with authorized devices. The module may support various short-range wireless technologies such as Bluetooth Low Energy (BLE), Near Field Communication (NFC), Wi-Fi Direct, ZigBee, or other proprietary protocols for power-efficient communications or higher bandwidth data transfer as needed. The wireless communication module 120 may enable rental staff to connect to the in-vehicle smoke detector 100 using mobile devices or specialized equipment to download event logs, update system settings, or perform diagnostic functions without requiring physical access to the internal components. The controller 106 may implement authentication and encryption mechanisms to ensure that only authorized devices can connect to and interact with the wireless communication module 120, protecting the system from unauthorized access or tampering.

The components of the in-vehicle smoke detector 100 may be arranged in a hierarchical structure, with the controller 106 managing inputs from the various sensors and modules. The power module 104 may distribute power to the system components, while the memory unit 108 may store operational data and recorded events. This hierarchical architecture enables efficient system operation, with the controller 106 serving as the central decision-making unit that processes inputs, executes detection algorithms, manages system resources, and controls communication functions. The interconnections between components may utilize various communication protocols such as I2C, SPI, UART, or direct analog and digital interfaces, depending on the bandwidth, latency, and reliability requirements of each connection. The physical arrangement of components within the in-vehicle smoke detector 100 may be optimized for thermal management, electromagnetic compatibility, and mechanical stability to ensure reliable operation in the automotive environment.

In some cases, the in-vehicle smoke detector 100 may include a tamper detection system. The tamper detection system may monitor air flow and composition to detect blocking of the air intake. The controller 106 may analyze data from the smoke sensor 102 to identify unusual patterns in air flow or composition that may indicate tampering attempts. If tampering is detected, the controller 106 may include this information alerting the rental company to potential unauthorized activities. The tamper detection functionality may employ multiple detection mechanisms working in concert to identify various tampering methods. For air flow monitoring, the system may establish baseline patterns during normal operation and detect significant deviations that could indicate deliberate obstruction of sensor inlets. The chemical composition analysis may identify sudden changes in air composition inconsistent with the vehicle environment, such as the introduction of substances intended to mask smoke particles or disable the sensor. The controller 106 may also monitor the physical orientation of the device using the accelerometer 114, detecting attempts to remove or reposition the unit. When tampering is detected, the system may implement countermeasures such as switching to backup sensing methods, increasing the frequency of data transmission while tampering is ongoing, or capturing additional contextual information to document the tampering attempt. This tamper detection capability adds another layer of security to the monitoring system, helping to ensure that the smoke detection and vehicle tracking functions remain operational even when faced with deliberate interference attempts.

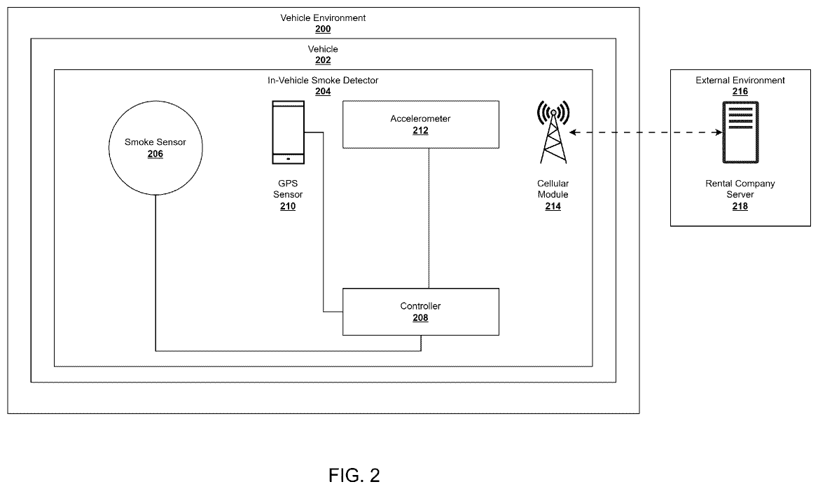

FIG. 2 illustrates a system diagram of a vehicle environment 200. The vehicle environment 200 represents a comprehensive operational ecosystem that encompasses both the physical vehicle 202 and the surrounding infrastructure necessary for monitoring and communication. The vehicle 202 is a discrete physical entity within this broader environment, containing the in-vehicle smoke detector 204 and serving as the primary monitoring subject. The vehicle environment 200 extends beyond the physical boundaries of the vehicle 202 to include external systems, communication networks, and data processing infrastructure that enable the complete functionality of the monitoring system. The in-vehicle smoke detector 204 may comprise multiple interconnected components for monitoring and communicating vehicle conditions. The system diagram depicts both the in-vehicle components and their relationship to external systems, illustrating the comprehensive monitoring and communication architecture that enables real-time tracking and event notification capabilities.

The in-vehicle smoke detector 204 may include a smoke sensor 206 connected to a controller 208. The smoke sensor 206 may be configured to detect particles and chemicals associated with smoke within the vehicle cabin. The controller 208 may process inputs from various sensors, including the smoke sensor 206, to determine if a smoking event has occurred. The smoke sensor 206 may utilize multiple detection technologies to identify different types of smoke particles and chemical compounds. These technologies may include ionization chambers that detect changes in electrical conductivity when smoke particles enter the detection area, photoelectric elements that identify light scattering or absorption caused by smoke particles, and chemical-specific sensors that react to compounds found in tobacco, marijuana, or vaping emissions. The smoke sensor 206 may incorporate air sampling mechanisms to actively draw cabin air through the detection elements, improving response time and sensitivity compared to passive detection methods.

A GPS sensor 210 may be integrated into the in-vehicle smoke detector 204. The GPS sensor 210 may provide location data to the controller 208, allowing the system to record the geographic position of the vehicle 202 when specific events occur, such as detected smoking incidents. The GPS sensor 210 may continuously monitor the vehicle's position, calculating coordinates through triangulation of satellite signals. The sensor may include advanced features such as dead reckoning capabilities that use internal inertial measurements to maintain position tracking when satellite signals are temporarily unavailable. The GPS sensor 210 may also provide time synchronization for the system, ensuring accurate timestamps for all recorded events. The controller 208 may implement geofencing functionality using the GPS data, enabling location-based rules and alerts when the vehicle 202 enters or exits predefined geographic areas.

An accelerometer 212 may be included in the in-vehicle smoke detector 204. The accelerometer 212 may detect movement and acceleration of the vehicle 202, providing data to the controller 208 for analysis of potential accidents. The accelerometer 212 may sample movement data at high frequencies, capturing detailed information about vehicle dynamics during normal operation and accident scenarios.

The in-vehicle smoke detector 204 may incorporate a cellular module 214. The cellular module 214 may enable wireless communication capabilities, allowing the system to transmit data or alerts to external systems or recipients. The cellular module 214 may include comprehensive telecommunications functionality, including a cellular modem, radio frequency front-end components, and protocol stacks for establishing and maintaining connections to mobile networks. The module may support multiple frequency bands and network technologies to ensure connectivity across different geographic regions and service providers. The cellular module 214 may implement power-saving modes that balance communication readiness with energy efficiency, activating full-power transmission only when necessary for sending event notifications or responding to queries from the rental server 218. The module may include security features such as encrypted communications and authentication mechanisms to protect the integrity and confidentiality of transmitted data.

The vehicle environment 200 may extend beyond the vehicle 202 to include an external environment 216 containing a rental server 218. The cellular module 214 may enable wireless communication between the in-vehicle smoke detector 204 and the rental server 218. This communication link may allow for real-time transmission of data and alerts from the in-vehicle smoke detector 204 to the rental server 218. The external environment 216 represents the broader ecosystem in which the vehicle 202 operates, including cellular network infrastructure, cloud computing resources, and the rental company's information technology systems. The rental server 218 may be a dedicated physical server or a cloud-based computing resource that receives, processes, stores, and distributes information from multiple vehicles in the rental fleet. The server may implement database systems for organizing vehicle data, analytics engines for identifying patterns and trends, notification systems for alerting rental staff to significant events, and application programming interfaces (APIs) for integrating with other business systems such as customer relationship management or billing platforms.

In some cases, when the smoke sensor 206 detects a smoking event, the controller 208 may process this information along with location data from the GPS sensor 210. The controller 208 may then use the cellular module 214 to transmit a notification to the rental server 218, providing details about the smoking incident and the vehicle's location. This notification process may involve multiple steps, beginning with the smoke sensor 206 detecting characteristic particles or chemicals associated with smoking. The controller 208 may apply filtering algorithms to distinguish between actual smoking events and potential false positives from environmental sources. Once a smoking event is confirmed, the controller 208 may compile an event record that includes the timestamp, GPS coordinates, vehicle identifier, and specific details about the detected smoke characteristics. This information may be formatted into a structured data packet and transmitted through the cellular module 214 using secure communication protocols. The rental server 218 may receive this notification, log it in the database, and potentially trigger automated alerts to rental company personnel based on predefined business rules.

The accelerometer 212 may be used to detect sudden decelerations that may indicate a vehicle accident. In such cases, the controller 208 may retrieve the current location from the GPS sensor 210 and use the cellular module 214 to send an immediate alert to the rental server 218, including the vehicle's identifier and location. The accident detection process may involve continuous monitoring of acceleration data across multiple axes. The controller 208 may analyze this data using algorithms that identify characteristic patterns associated with collision events, such as rapid deceleration exceeding predetermined thresholds, followed by a sudden stop or change in vehicle orientation. When these patterns are detected, the controller 208 may immediately capture the current GPS coordinates, vehicle status information, and acceleration data surrounding the event. This information may be prioritized for immediate transmission through the cellular module 214, potentially using emergency messaging protocols that ensure delivery even in challenging network conditions. The rental server 218 may process these high-priority alerts differently from routine notifications, potentially triggering immediate response procedures such as contacting the renter, dispatching emergency services, or initiating recovery operations.

The components within the vehicle 202 may be arranged in a hierarchical structure, with the controller 208 managing inputs from the smoke sensor 206, GPS sensor 210, and accelerometer 212. The controller 208 may process this data and transmit relevant information through the cellular module 214 to the rental server 218 in the external environment 216. This hierarchical architecture establishes clear data flow paths and processing responsibilities within the system. The controller 208 serves as the central intelligence that coordinates all monitoring, detection, and communication functions. Sensor inputs flow into the controller 208, where they undergo initial processing, filtering, and event detection analysis. The controller 208 may implement different processing priorities for various types of events, ensuring that critical situations such as accidents receive immediate attention while routine monitoring continues in the background. The communication between components may utilize standardized interfaces and protocols to ensure reliable data transfer and system expandability. The physical integration of these components within the vehicle 202 may be designed to minimize installation complexity while maximizing detection effectiveness and communication reliability.

This configuration may allow for real-time monitoring and communication between the vehicle 202 and the rental company's systems, enabling prompt responses to smoking incidents, accidents, or other events of interest. The rental server 218 may receive and process the data from multiple vehicles, providing the rental company with a comprehensive overview of their fleet status and any issues that may require attention. The real-time monitoring capabilities create a continuous information flow that transforms traditional rental vehicle management into a dynamic, data-driven operation. When smoking incidents are detected, the rental company can document the event with precise timestamps and location data, potentially using this information for customer discussions and appropriate cleaning fee assessments. In accident scenarios, the immediate notification and location information can dramatically reduce vehicle recovery times and associated costs. The rental server 218 may implement sophisticated data management systems that organize information from the entire fleet, enabling both immediate operational responses and longer-term analytics for business optimization. The server may also integrate with customer communication systems, allowing automated updates to renters about vehicle status or policy reminders based on detected events.

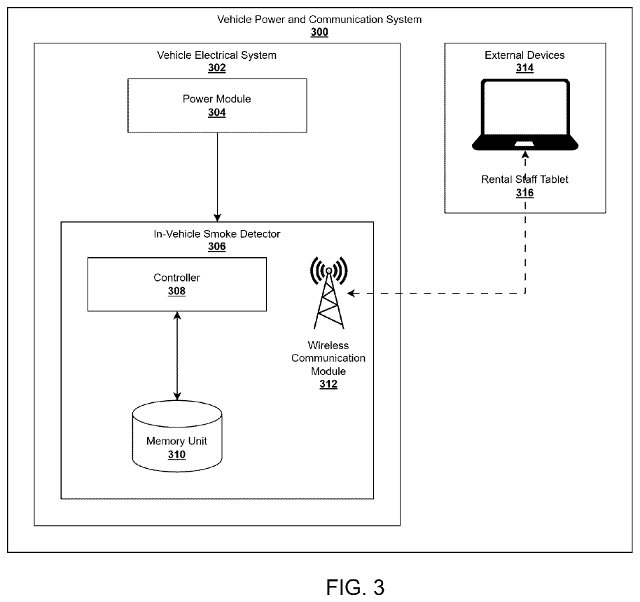

FIG. 3 illustrates a block diagram of a vehicle power and communication system 300. The vehicle power and communication system 300 may include a vehicle electrical system 302, which may contain a power module 304 and a smoke detector 306. The block diagram depicts the electrical and communication architecture that enables the smoke detection system to operate reliably within the vehicle environment while facilitating data exchange with external devices used by rental company personnel.

The smoke detector 306 may comprise a controller 308 that connects to a memory unit 310. The smoke detector 306 may also include a wireless communication module 312 for wireless communication capabilities. The controller 308 represents the central processing element of the smoke detector 306, containing the computational resources and firmware necessary to manage system operations. The controller 308 may be implemented using a microcontroller architecture that integrates processing cores, memory interfaces, and input/output peripherals into a single component. The controller 308 may execute real-time operating system functions to manage multiple tasks simultaneously, such as sensor monitoring, event detection, data logging, and communication control. The memory unit 310 provides non-volatile storage for system configuration, operational parameters, and event data. The memory architecture may include multiple types of storage media, such as flash memory for program storage and EEPROM for configuration settings, organized in a file system that facilitates data management and retrieval.

The vehicle power and communication system 300 may interface with external devices 314, which may include a rental staff tablet 316. The wireless communication module 312 may enable wireless communication between the smoke detector 306 and the rental staff tablet 316. The external devices 314 represent the various equipment used by rental company personnel to interact with the vehicle monitoring systems. The rental staff tablet 316 may be a specialized mobile computing device configured with software applications designed specifically for accessing and managing vehicle monitoring data. These applications may provide user interfaces for viewing event logs, configuring system parameters, performing diagnostics, and generating reports. The wireless communication module 312 establishes a secure wireless communication channel between the smoke detector 306 and the rental staff tablet 316, implementing pairing procedures, encryption protocols, and authentication mechanisms to ensure that only authorized devices can access the system. The communication protocol may define specific message formats and interaction sequences for different operations such as data retrieval, configuration updates, and diagnostic testing.

In some cases, the power module 304 may connect to the smoke detector 306, providing electrical power for operation of the smoke detector's components. The controller 308 may manage the operation of the smoke detector 306, processing data and controlling communication through the wireless communication module 312. The memory unit 310 may store data that can be transmitted to the rental staff tablet 316 via the wireless connection. The power module 304 serves as the interface between the vehicle electrical system 302 and the smoke detector 306, converting and conditioning the vehicle's electrical power to meet the specific voltage, current, and stability requirements of the smoke detector components. The power module 304 may incorporate surge protection circuits to shield the smoke detector 306 from potentially damaging electrical transients that can occur in automotive environments. The module may also include power filtering and regulation components to ensure clean, stable power delivery despite variations in the vehicle's electrical system. In some implementations, the power module 304 may include backup power capabilities such as supercapacitors or small rechargeable batteries that can maintain critical functions during brief interruptions in vehicle power, such as during engine starting or battery replacement.

The components may be arranged in a hierarchical structure within the vehicle electrical system 302, with the power module 304 supplying power to the smoke detector 306. The smoke detector 306 may contain the internal components (controller 308, memory unit 310, and wireless communication module 312) that enable its monitoring and communication functions. This hierarchical arrangement establishes clear power distribution and functional relationships between the components. The vehicle electrical system 302 represents the primary power source, typically derived from the vehicle's battery and charging system. The power module 304 serves as the power conditioning and distribution interface, ensuring that the smoke detector 306 receives appropriate electrical power regardless of variations in the vehicle's electrical system. Within the smoke detector 306, the controller 308 functions as the central management unit, coordinating the operations of the memory unit 310 and wireless communication module 312. This structured approach to system organization facilitates efficient power management, reliable operation, and clear functional separation between different system elements.

In some implementations, the vehicle electrical system 302 may provide a stable power source for the smoke detector 306 through the power module 304. This configuration may ensure continuous operation of the smoke detector 306 without relying on separate batteries or external power sources. The vehicle electrical system 302 typically includes the vehicle's battery, alternator, voltage regulator, and associated wiring and distribution components. These elements work together to maintain a nominal 12-volt DC power supply (in most passenger vehicles) that powers various vehicle systems and accessories. The connection between the vehicle electrical system 302 and the power module 304 may be implemented through direct wiring to the vehicle's fuse box or power distribution panel, potentially using circuits that remain energized even when the ignition is off to enable continuous monitoring. The power module 304 may incorporate intelligent power management features that adjust the smoke detector's operating mode based on the vehicle's electrical status. For example, when the engine is running and the alternator is charging the battery, the system may operate in full-power mode with all sensors and communication capabilities active. When the vehicle is parked with the engine off, the system may transition to a low-power monitoring mode that maintains essential detection functions while minimizing current draw from the vehicle battery.

The wireless communication module 312 may facilitate short-range wireless communication between the smoke detector 306 and the rental staff tablet 316. This communication link may allow rental company personnel to retrieve stored data from the memory unit 310 during vehicle check-in or maintenance procedures. For example, smoking event logs, vehicle movement data, or other relevant information collected by the smoke detector 306 may be transferred to the rental staff tablet 316 for review and analysis. The wireless communication module 312 may implement various wireless technologies such as Bluetooth Low Energy (BLE), Wi-Fi, Near Field Communication (NFC), or other proprietary protocols that enable energy-efficient wireless communication with ranges suitable for close-proximity operations typical in vehicle check-in scenarios. The module may support various communication profiles and services that define specific communication capabilities, such as structured data exchange protocols or device information services for system identification. The communication process may begin with a discovery phase where the rental staff tablet 316 scans for available wireless devices and identifies the smoke detector 306 based on its unique identifier. After establishing a connection, the tablet may authenticate itself to the smoke detector 306 using secure credentials. Once authenticated, the tablet can request specific data types from the memory unit 310, such as smoking event logs from a particular rental period. The controller 308 retrieves this information from the memory unit 310 and formats it for transmission through the wireless communication module 312 using standardized data structures that ensure compatibility with the tablet application.

In some cases, the controller 308 may manage the data transfer process, ensuring that only authorized devices, such as the rental staff tablet 316, can access the information stored in the memory unit 310. This may help maintain data security and privacy for the rental company and its customers. The controller 308 may implement multiple layers of security to protect the system and its data. At the device level, the controller 308 may maintain a whitelist of authorized wireless device identifiers that are permitted to connect to the system. When a connection request is received, the controller 308 verifies the requesting device's identifier against this whitelist before proceeding. For authentication, the controller 308 may implement challenge-response protocols that require the connecting device to provide valid credentials, such as digital certificates or cryptographic keys. These credentials may be specific to each rental company or even to individual staff members, enabling granular access control. Once a device is authenticated, the controller 308 may enforce role-based access controls that determine which types of data and system functions the connected device is authorized to access. For example, regular rental staff might only have access to smoking event logs, while maintenance personnel might have additional access to system diagnostic information. All communication between the smoke detector 306 and the rental staff tablet 316 may be encrypted using industry-standard protocols to prevent eavesdropping or data interception.

The vehicle power and communication system 300 may provide a comprehensive solution for powering the smoke detector 306 and enabling efficient data retrieval by rental company staff. By integrating with the vehicle electrical system 302 and utilizing wireless communication technologies for communication, the system may offer a reliable and user-friendly method for monitoring and managing rental vehicles. The integration with the vehicle electrical system 302 eliminates the need for separate power sources or regular battery replacements, reducing maintenance requirements and ensuring continuous operation throughout the vehicle's rental cycle. The power module 304 serves as a critical interface that protects the smoke detector 306 from electrical anomalies while providing stable power under various vehicle operating conditions. The wireless communication capability creates a streamlined workflow for rental staff, allowing them to quickly retrieve monitoring data during vehicle check-in without requiring physical access to the smoke detector 306 or specialized connection cables. The rental staff tablet 316 may run custom software applications that automatically process the retrieved data, potentially highlighting policy violations, generating cleaning fee assessments, or updating the rental company's central management systems with vehicle status information. This integrated approach to power management and data communication enhances operational efficiency while providing the rental company with reliable documentation of vehicle usage patterns and potential policy violations.

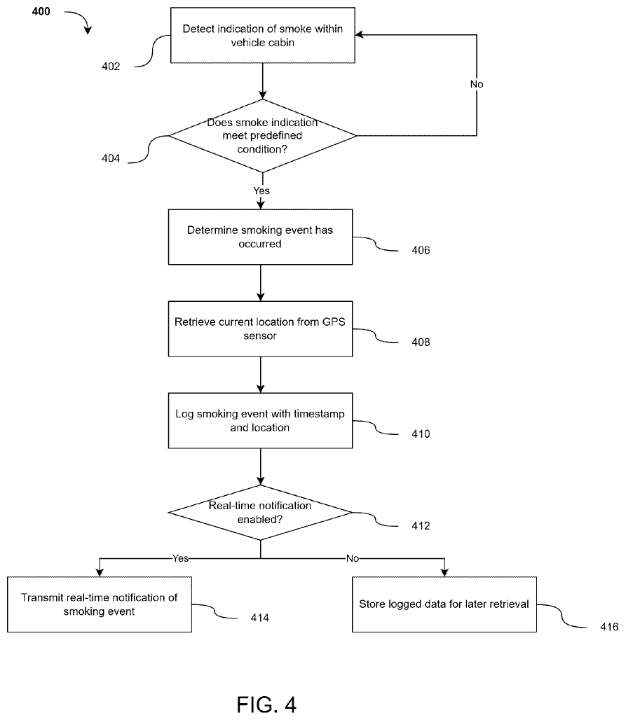

FIG. 4 illustrates a flowchart for a method 400 of detecting and logging smoking events within a vehicle cabin. The method 400 may be implemented by the in-vehicle smoke detector 100 described in previous figures. The flowchart provides a systematic approach to monitoring, validating, recording, and reporting smoking incidents detected within the vehicle environment.

The method 400 may begin with a step 402, where the in-vehicle smoke detector 100 detects an indication of smoke within the vehicle cabin. In some cases, the smoke sensor 102 may be used to detect particles or chemicals associated with smoke. The smoke sensor 102 may continuously sample the air within the vehicle cabin, analyzing particulate density and chemical composition to identify potential smoking activities. This detection process may involve multiple sensing technologies working in concert, including ionization detection for smaller smoke particles, photoelectric detection for larger smoke particles, and chemical analysis for specific compounds associated with tobacco, marijuana, or vaping emissions.

The process may then move to a step 404 where the controller 106 determines if the smoke indication meets a predefined condition. The controller 106 may employ a specialized detection algorithm that requires a certain number of event detections over consecutive measurement intervals before considering a smoking event to have occurred. This approach may help reduce false positives and increase the accuracy of smoke detection. The algorithm may incorporate temporal analysis, examining the persistence and pattern of smoke indicators over time rather than relying on isolated readings. For example, the system might require three consecutive positive readings within a five-minute window before confirming a smoking event, distinguishing between momentary environmental smoke and sustained smoking activity within the vehicle.

In some implementations, the controller 106 may adjust the measurement threshold for smoke detection based on operational conditions of the vehicle 202. For example, when the vehicle 202 is operating in urban areas with high levels of smog, the controller 106 may increase the threshold to account for higher ambient particulate levels. The controller 106 may utilize GPS data to determine the vehicle's location and apply location-specific threshold adjustments based on known environmental conditions in different geographic areas. Additionally, the controller 106 may implement adaptive learning algorithms that analyze historical sensor data to establish baseline readings for different environments and driving conditions, further refining the detection accuracy over time.

If the predefined condition is not met, the method 400 may return to step 402 to continue monitoring. This creates a continuous monitoring loop that maintains vigilance for smoking activities throughout the vehicle's operation. If the smoke indication meets the predefined condition, the process may proceed to a step 406, where the controller 106 determines a smoking event has occurred. This determination represents a high-confidence conclusion based on the accumulated sensor data and analysis that smoking has taken place within the vehicle cabin, triggering subsequent logging and notification procedures.

Following this determination, the method 400 may advance to a step 408, where the current location is retrieved from the GPS sensor 112. This location data may be used to provide context for the detected smoking event. The GPS sensor 112 may capture precise coordinates including latitude, longitude, and potentially altitude information. In areas with poor GPS reception, such as tunnels or parking garages, the system may utilize last known coordinates or implement dead reckoning techniques based on accelerometer data to estimate the vehicle's position. The location information adds valuable context to the smoking event record, potentially helping rental companies identify patterns of policy violations in specific geographic areas.

The method 400 may then move to a step 410, where the smoking event is logged with a timestamp and location in the memory unit 108. This logged data may be used later for analysis or enforcement of smoking policies. The logging process may create a structured data record that includes multiple fields such as event type, detection confidence level, timestamp with date and time, GPS coordinates, vehicle identifier, and potentially the type of smoke detected (tobacco, marijuana, vaping, etc.). The memory unit 108 may organize these records in a database structure that facilitates efficient storage and retrieval, with indexing by time, location, and event type to enable various query operations during later analysis.

At a step 412, the method 400 may evaluate whether real-time notification is enabled. This decision point allows the system to operate in different communication modes based on configuration settings or operational requirements. If real-time notification is enabled, the process may proceed to a step 414, where a real-time notification of the smoking event is transmitted using the cellular module 116. This notification may be sent to the rental server 218 or other designated recipients. The real-time notification may be formatted as a structured data packet containing the event details, vehicle identifier, timestamp, and location information. The cellular module 116 may utilize available cellular networks to transmit this data, potentially implementing retry mechanisms if initial transmission attempts fail due to poor network coverage. The notification may trigger automated alerts within the rental company's systems, potentially sending text messages or emails to designated personnel who can take appropriate action.

If real-time notification is not enabled, the method 400 may move to a step 416, where the logged data is stored in the memory unit 108 for later retrieval. This data may be accessed later using the wireless communication module 120, for example, when the vehicle 202 is returned to the rental company. The memory unit 108 may implement circular buffer techniques to manage storage capacity, ensuring that the most recent events are preserved even if the storage capacity is limited. The stored data may be organized in a format that facilitates efficient transfer when retrieved, potentially including compression techniques to maximize the amount of information that can be stored. When the vehicle returns to the rental facility, staff can use authorized devices to connect to the wireless communication module 120 and download the complete event history, which may then be integrated into the rental company's customer and vehicle management systems.

The method 400 may provide a comprehensive approach to detecting, logging, and reporting smoking events within the vehicle cabin. By incorporating adjustable thresholds and a specialized detection algorithm, the method 400 may offer improved accuracy in various operational conditions while maintaining a record of smoking incidents for rental company use. The multi-stage process ensures that smoking events are reliably detected, accurately documented with contextual information, and appropriately communicated based on system configuration. This systematic approach helps rental companies enforce non-smoking policies with objective evidence, potentially reducing disputes with customers and recovering appropriate cleaning fees when necessary. The flexibility of the notification system allows rental companies to choose between immediate alerts for real-time response or batch processing during vehicle return procedures, depending on their operational preferences and business requirements.

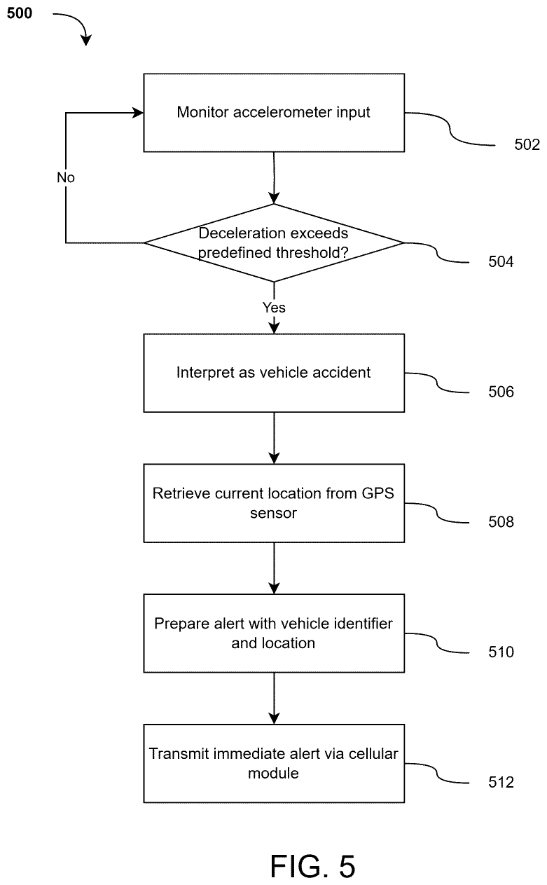

FIG. 5 illustrates a flowchart for a method 500 of monitoring and responding to vehicle accidents. The method 500 may be implemented by the in-vehicle smoke detector 100 described in previous figures. The flowchart presents a systematic approach to detecting collision events, capturing critical location data, and transmitting emergency notifications to enable rapid response to vehicle accidents.

The method 500 may begin with a step 502, where the accelerometer 114 monitors input related to the vehicle's movement and acceleration. The controller 106 may continuously receive and process this input from the accelerometer 114. The accelerometer 114 may sample acceleration forces across multiple axes at high frequency, typically 50-100 times per second or higher, to capture detailed motion profiles of the vehicle. This continuous monitoring creates a comprehensive record of the vehicle's movement patterns, including acceleration, deceleration, turns, and vibrations. The controller 106 may apply initial filtering to this raw accelerometer data to remove noise and identify significant motion events for further analysis, while maintaining a rolling buffer of recent acceleration data that can be analyzed in detail when potential accident scenarios are detected.

The process may then move to a step 504 where the controller 106 determines if the deceleration detected by the accelerometer 114 exceeds a predefined threshold. This threshold may be set to identify sudden decelerations that are indicative of a vehicle accident. The deceleration analysis may examine both the magnitude and rate of change of the deceleration force, as vehicle accidents typically involve rapid onset of high g-forces. The controller 106 may implement multi-dimensional analysis that considers deceleration across all three axes (forward/backward, side-to-side, and vertical), as different types of collisions produce characteristic force patterns in different directions. For example, rear-end collisions primarily generate forces along the vehicle's longitudinal axis, while side impacts produce strong lateral forces. By analyzing the complete acceleration vector, the system can better distinguish between normal driving maneuvers and actual collision events.

In some cases, the controller 106 may adjust the deceleration threshold based on various factors such as the vehicle's speed, road conditions, or historical data. This adaptive approach may help improve the accuracy of accident detection while reducing false positives. For instance, the system might apply lower deceleration thresholds when the vehicle is traveling at higher speeds, as even moderate deceleration forces can indicate significant incidents at high velocity. Conversely, higher thresholds might be applied during low-speed maneuvering in parking lots where brief but sharp decelerations are normal. The controller 106 may also incorporate contextual information from the GPS sensor 112, such as the type of road being traveled (highway, city street, parking area) to further refine the threshold selection. Additionally, the system may implement pattern recognition algorithms that analyze the sequence and timing of acceleration changes rather than isolated readings, helping to distinguish between emergency braking scenarios and actual collisions.

If the deceleration does not exceed the predefined threshold, the method 500 may return to step 502 to continue monitoring accelerometer input. This creates a continuous monitoring loop that maintains vigilance for accident scenarios throughout the vehicle's operation. If the deceleration exceeds the predefined threshold, the process may proceed to a step 506, where the controller 106 interprets the event as a vehicle accident. This determination represents a high-confidence conclusion based on the accelerometer data analysis that a collision or similar high-impact event has occurred, triggering the emergency notification sequence. The system may also capture and preserve a detailed record of the acceleration data surrounding the event, including pre-impact and post-impact motion patterns, which could provide valuable information for accident reconstruction and analysis.

Following this determination, the method 500 may advance to a step 508, where the current location is retrieved from the GPS sensor 112. This location data may be crucial for providing accurate information about the accident site to relevant parties. The GPS sensor 112 may capture precise coordinates including latitude, longitude, altitude, and potentially heading information that indicates the vehicle's direction of travel at the time of impact. The system may prioritize obtaining the most accurate location possible, potentially activating high-precision GPS modes or combining multiple location determination methods. In areas with poor GPS reception, the system may utilize last known coordinates, cellular tower triangulation, or nearby Wi-Fi network information to estimate the vehicle's position. The location information is critical for emergency responders and recovery services to quickly locate the vehicle, particularly in remote areas or complex road networks where verbal descriptions might be inadequate.

The method 500 may then move to a step 510, where the controller 106 prepares an alert with the vehicle identifier and location. The vehicle identifier may be a unique code or registration number associated with the specific vehicle 202, which may help the rental company or emergency services quickly identify the vehicle involved in the accident. The alert preparation process may involve compiling a comprehensive data package that includes multiple elements: the vehicle's unique identifier, precise GPS coordinates in a standardized format, timestamp of the incident, severity assessment based on deceleration magnitude, vehicle heading at time of impact, and potentially the vehicle's speed immediately before the incident. The controller 106 may format this information according to predefined templates that ensure compatibility with the rental company's systems and emergency response protocols. The alert may also include information about the vehicle make, model, color, and license plate to assist first responders in identifying the vehicle at the scene.

Finally, in a step 512, an immediate alert may be transmitted via the cellular module 116. This alert may be sent to the rental server 218 or other designated recipients, such as emergency services or the rental company's incident response team. The cellular module 116 may implement priority transmission protocols that ensure the emergency message receives precedence over routine data communications. The system may utilize multiple transmission attempts and fallback communication methods to maximize the probability of successful message delivery even in challenging network conditions. For instance, if high-bandwidth data transmission is unavailable, the system might fall back to SMS text messaging or even voice calls to emergency numbers with automated location announcements. The cellular module 116 may also be configured to maintain an open communication channel after the initial alert, enabling the rental company or emergency services to request additional information or updates about the vehicle's status.

In some implementations, the controller 106 may include additional information in the alert, such as the severity of the deceleration, the vehicle's speed at the time of the incident, or data from other sensors in the in-vehicle smoke detector 100. This additional information may help responders better assess the situation and prepare an appropriate response. The controller 106 may calculate an estimated impact severity based on the deceleration magnitude and vehicle speed, potentially categorizing the incident as minor, moderate, or severe to help prioritize emergency response. The system might also include information about the direction of impact (frontal, side, rear) based on the axis of maximum deceleration, helping responders anticipate the types of injuries that might have occurred. If the vehicle continues to move after the impact, the system may provide updates on its post-accident trajectory and final resting position. The controller 106 may also monitor for secondary impacts that might occur after the initial collision, updating the alert with comprehensive information about complex accident scenarios involving multiple collision events.

The method 500 may provide a comprehensive approach to detecting and responding to vehicle accidents. By leveraging the accelerometer 114 for accident detection, the GPS sensor 112 for location data, and the cellular module 116 for immediate communication, the method 500 may enable rapid response to accidents involving rental vehicles, potentially improving safety outcomes and reducing vehicle recovery times. The systematic process ensures that accident events are reliably detected using sophisticated analysis of motion data, precisely located using advanced positioning technologies, and promptly reported through priority communication channels. This approach helps rental companies quickly locate and recover damaged vehicles, potentially reducing costs associated with extended search efforts and impound fees. More importantly, the immediate notification capability may facilitate faster emergency response to accident scenes, which could be critical in situations where vehicle occupants require medical assistance. The comprehensive data provided in the accident alerts also creates an objective record of the incident circumstances, which may be valuable for insurance claims processing and accident investigations.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

1. An in-vehicle smoke detection system, comprising:
a smoke sensor comprising at least one of an ionization sensor, a photoelectric sensor, and a chemical sensor, configured to detect particulate matter and chemical compounds associated with smoke within a vehicle cabin;
a controller comprising a processor and executable instructions stored in non-transitory memory, the controller communicatively coupled to the smoke sensor;
a memory unit comprising non-volatile storage communicatively coupled to the controller; and
a power module comprising at least one of a rechargeable battery, a solar charging circuit, and a vehicle power interface, configured to power the system,
wherein the controller is configured to execute instructions to detect a smoking event based on data from the smoke sensor by analyzing air composition changes over a predetermined time interval and log the smoking event with a timestamp in the memory unit.

2. The in-vehicle smoke detection system of claim 1, further comprising a GPS sensor communicatively coupled to the controller, wherein the controller is further configured to log location data associated with the smoking event.

3. The in-vehicle smoke detection system of claim 2, further comprising a cellular module communicatively coupled to the controller, wherein the controller is further configured to transmit a notification of the smoking event via the cellular module.

4. The in-vehicle smoke detection system of claim 3, further comprising an accelerometer communicatively coupled to the controller, wherein the controller is further configured to detect a rapid deceleration event based on data from the accelerometer and transmit a notification of the rapid deceleration event via the cellular module.

5. The in-vehicle smoke detection system of claim 4, wherein the controller is further configured to detect cabin air quality deterioration based on data from an air quality sensor indicating pollutant levels exceeding a predetermined threshold.

6. The in-vehicle smoke detection system of claim 1, further comprising an acoustic sensor communicatively coupled to the controller, wherein the controller is further configured to detect animal sounds based on data from the acoustic sensor and log an animal detection event in the memory unit.

7. The in-vehicle smoke detection system of claim 1, wherein the controller is further configured to detect tampering with the smoke sensor based on air flow patterns and air composition changes detected by the smoke sensor.

8. The in-vehicle smoke detection system of claim 1, wherein the smoke sensor is configured to detect smoke from cigarettes, cigars, tobacco pipes, e-cigarettes, vape pens, and marijuana.

9. The in-vehicle smoke detection system of claim 1, wherein the controller is configured to execute a detection algorithm that determines a smoking event has occurred based on a predefined number of smoke detections over a series of measurement intervals.

10. A method for detecting smoking events in a vehicle, comprising:
detecting, via a smoke sensor comprising at least one of an ionization sensor, a photoelectric sensor, and a chemical sensor, an indication of smoke within a vehicle cabin by measuring particulate density and chemical compound concentrations in the vehicle cabin air;
determining, by a controller executing a predefined detection algorithm, that a smoking event has occurred based on analyzing a time-series of sensor readings against predetermined threshold values and pattern recognition criteria; and
logging the smoking event with a timestamp and event identifier in a non-volatile memory unit.

11. The method of claim 10, further comprising retrieving, by the controller, location data from a GPS sensor and logging the location data associated with the smoking event in the memory unit.

12. The method of claim 11, further comprising transmitting, via a cellular module, a notification of the smoking event to a remote server.

13. The method of claim 12, further comprising:
detecting, by an accelerometer, a rapid deceleration event; and
transmitting, via the cellular module, a notification of the rapid deceleration event to the remote server.

14. The method of claim 13, further comprising:
detecting, by the accelerometer, vehicle movement while a vehicle ignition is off; and
transmitting, via the cellular module, periodic location updates to the remote server.

15. The method of claim 10, further comprising detecting animal sounds via an acoustic sensor and logging an animal detection event in the memory unit.

16. The method of claim 10, further comprising detecting tampering with the smoke sensor based on air flow patterns and air composition changes.

17. The method of claim 10, wherein the smoke sensor is configured to detect smoke from cigarettes, cigars, tobacco pipes, e-cigarettes, vape pens, and marijuana.

18. The method of claim 10, wherein the predefined detection algorithm determines a smoking event has occurred based on a predefined number of smoke detections over a series of measurement intervals.

19. An in-vehicle monitoring system, comprising:
a smoke sensor comprising at least one of an ionization sensor, a photoelectric sensor, and a chemical sensor, configured to detect particulate matter and chemical compounds associated with smoke within a vehicle cabin;
a GPS sensor comprising a satellite signal receiver and positioning circuitry configured to determine vehicle location coordinates;
a controller comprising a microprocessor and executable instructions stored in non-transitory memory, the controller communicatively coupled to the smoke sensor, accelerometer, and GPS sensor through a digital communication bus; and
a cellular module comprising a wireless transceiver communicatively coupled to the controller,
wherein the controller is configured to detect a smoking event based on data from the smoke sensor by analyzing air composition changes over a predetermined time interval and, when a smoking event is detected, transmit a notification via the cellular module to a remote server using data transmission.

20. The in-vehicle monitoring system of claim 19, further comprising an acoustic sensor communicatively coupled to the controller, wherein the controller is configured to detect animal sounds based on data from the acoustic sensor and log an animal detection event in a memory unit, and wherein the controller is further configured to detect tampering with the smoke sensor based on air flow patterns and air composition changes detected by the smoke sensor.
